(19) United States
(12) Patent Application Publication
(10) Pub. No.: US 2011/0210474 A1
(43) Pub. Date: Sep. 1, 2011

(54) DRILL BIT WITH INTEGRAL CUTTINGS SPLITTER AND METHOD OF MAKING

(75) Inventors: Timothy K. Marvel, The Woodlands, TX (US); Michael R. Wells, Lakewood, CO (US)

(73) Assignee: BAKER HUGHES INCORPORATED, Houston, TX (US)

(21) Appl. No.: 13/105,365

(22) Filed: May 11, 2011

Related U.S. Application Data
(62) Division of application No. 12/396,881, filed on Mar. 3, 2009.

(51) Int. Cl. B29C 33/42

(52) U.S. Cl. 264/219

(57) ABSTRACT

A method of making a drill bit for drilling subterranean formations includes, forming a bit mold defining the drill bit to include at least one recess defining at least one splitter, and filling the bit mold with at least one material.

### CROSS REFERENCE TO RELATED APPLICATION

This application is a divisional application of U.S. patent application Ser. No. 12/396,881, filed Mar. 3, 2009, the entire contents of which are incorporated herein by reference.

### BACKGROUND

In the hydrocarbon drilling industry, rotary drill bits that drill into subterranean formations form cuttings that are carried away with drilling fluid that is pumped through the drill bit. Junk slots are provided in the drill bit to permit passage therethrough of the drilling fluid and the cuttings carried therewith. Cuttings, however, can be of a size that they become lodged in the junk slots thereby blocking the junk slots and detrimentally affecting a rate of penetration of the drilling operation. Systems and methods to lessen occurrences of these conditions are well received in the art.

### BRIEF DESCRIPTION

Disclosed herein is a downhole drill bit. The drill bit includes, a body, a plurality of cutters attached to the body, and at least one splitter that is integrally formed in the body is in operable communication with at least one of the plurality of cutters such that the splitter bifurcates cuttings cut by the at least one cutter.

Further disclosed herein is a method of making a downhole bit with integral splitters. The method includes, milling a body of the downhole bit, and removing material from the body leaving at least one splitter protruding from at least one surface of the body.

Further disclosed herein is a method of making a drill bit for drilling subterranean formations. The method includes, forming a bit mold defining the drill bit to include at least one recess defining at least one splitter, and filling the bit mold with at least one material.

### BRIEF DESCRIPTION OF THE DRAWINGS

The following descriptions should not be considered limiting in any way. With reference to the accompanying drawings, like elements are numbered alike:

FIG. 1 depicts a partial perspective view of a downhole drill bit disclosed herein;

FIG. 2 depicts a partial perspective view of an alternate downhole drill bit disclosed herein;

FIG. 3A depicts a partial front view of the downhole drill bit of FIG. 1;

FIG. 3B depicts a partial side cross-sectional view of the downhole drill bit of FIG. 3A;

FIG. 4A depicts a partial front view of an alternate downhole drill bit disclosed herein;

FIG. 4B depicts a partial side cross-sectional view of the downhole drill bit of FIG. 4A; and

FIG. 5 depicts a cross-sectional view of a bit mold containing the drill bit of FIG. 2.

### DETAILED DESCRIPTION

A detailed description of one or more embodiments of the disclosed apparatus and method are presented herein by way of exemplification and not limitation with reference to the Figures.

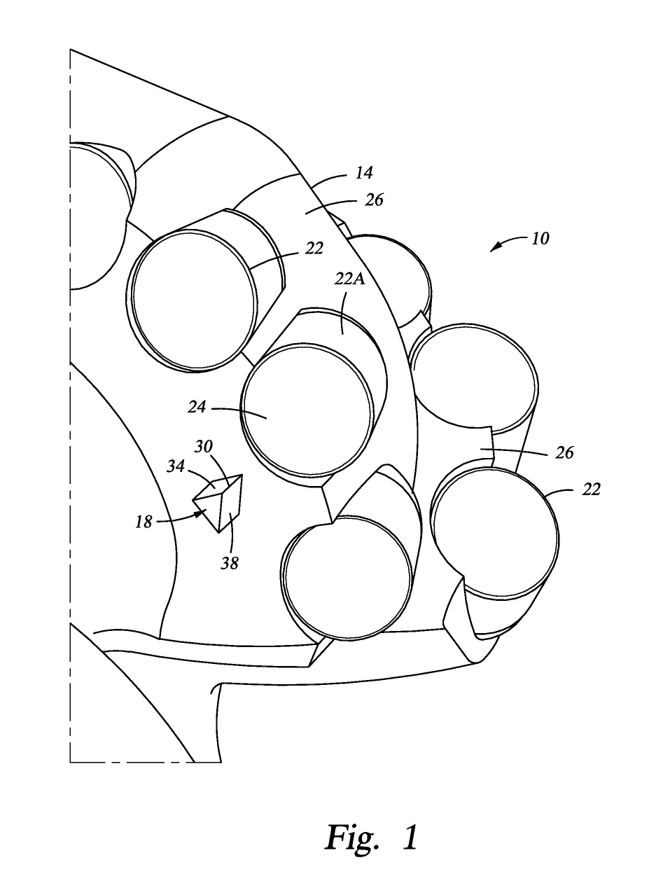

Referring to FIG. 1, an embodiment of a downhole drill bit 10 disclosed herein is illustrated. The drill bit 10 includes, a body 14 with an integral cuttings splitter 18 and a plurality of cutters 22 attached thereto. The splitter 18 is configured to bifurcate cuttings, or chips, that are cut from a formation by the cutter 22A. By bifurcating the cuttings into smaller pieces, junk slots positioned between perimetrically adjacent blades 26 of the body 14 are less likely to become blocked or plugged. The splitter 18 has a splitter edge 30 defined by an intersection between surfaces 34 and 38. The surfaces 34 and 38 of this embodiment are polished, however, other embodiments may use unpolished surfaces or surfaces modified by inclusion of one or more of, dimples, polytetrafluoroethylene (PTFE) treating, chrome plating, hardfacing, physical vapor deposition (PVD)/chemical vapor deposition (CVD) coatings and combinations thereof Making the splitter edge 30 sharp can improve the operational efficiency of the splitter 18. The edge of the splitter 18 can be perpendicular to the cutter 22 as illustrated in this embodiment or slanted, for example, such that a distal portion of the splitter edge 30 is nearer the cutter 22 than a proximal point. Slanting the splitter edge 30 in this manner increases the likelihood that cuttings will be “trapped” by the splitter 18 increasing the likelihood that cuttings will be bifurcated rather than just pass over the splitter 18.

The splitter 18 is integrally formed as part of the body 14 as will be described in greater detail below. Making the splitter 18 integral with the body 14 avoids some drawbacks associated with alternate methods of attaching splitters to bodies. For example, welding splitters to bodies form heat-affected zones in both of the parent materials of the splitter and the body that can negatively impact the structural characteristics of the parent materials such as hardness and strength as well as locally changing the parent material structure to one more prone to erosion, abrasion and corrosion. Welding also has inherent variability in the process itself due to all the variables that must be controlled as well as having limitations in a depth-of-penetration beyond the surfaces where the weld is performed. Soldering or brazing also has drawbacks, which include, variation in bond integrity between each of the parent materials and the third brazing material introduced, and limitations in temperatures during use due to the lower melting temperature of the third brazing material. Additionally, variability in the process parameters such as the rate of temperature change, surface preparation and fit of the bonding surfaces and the potential for contamination and gas pockets within the brazed joint, all can negatively effect the integrity of the bond. Strictly mechanical attachments can have limitations as well, including, displacement of parent material for routing of the fasteners and potentially inherent areas of stress concentration due to the geometric requirements of the mechanical attachments themselves. Making the splitter 18 integrally with the body 14 as disclosed herein avoids these concerns.

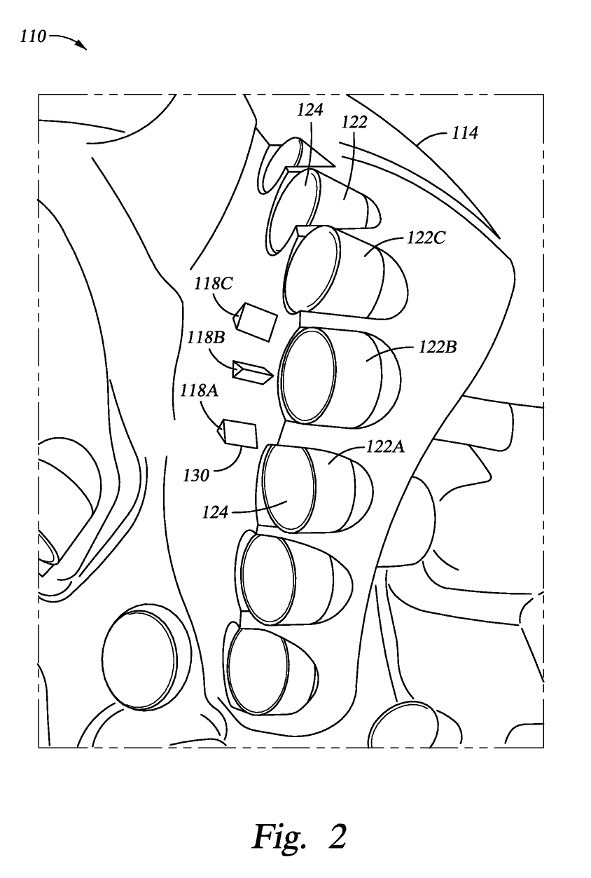

Referring to FIG. 2, an alternate embodiment of a downhole drill bit 110 disclosed herein is illustrated. The drill bit 110 includes three integrally formed splitters 118A, 118B and 118C; however, alternate embodiments may have any number of splitters 118 including one in operable communication with every one of cutters 122, for example. In this embodiment the splitters 118A, 118B, 118C are in operable communication with the cutters 122A, 122B, 122C, respectively. Each of the splitters 118 is positioned downstream from its respective cutter 122 with the downstream orientation being defined by a relative direction of travel of cuttings produced by each cutter 122. For example, cuttings produced by the cutter 122A travel across cutter face 124A and into the splitter 118A. The splitters 118 each have a splitter edge 130 positioned substantially central to the cuttings contacting therewith to bifurcate the cuttings substantially into two more or less equal portions. The relative positioning of the splitter edge 130 to the face 124 can vary depending upon specifics of each application.

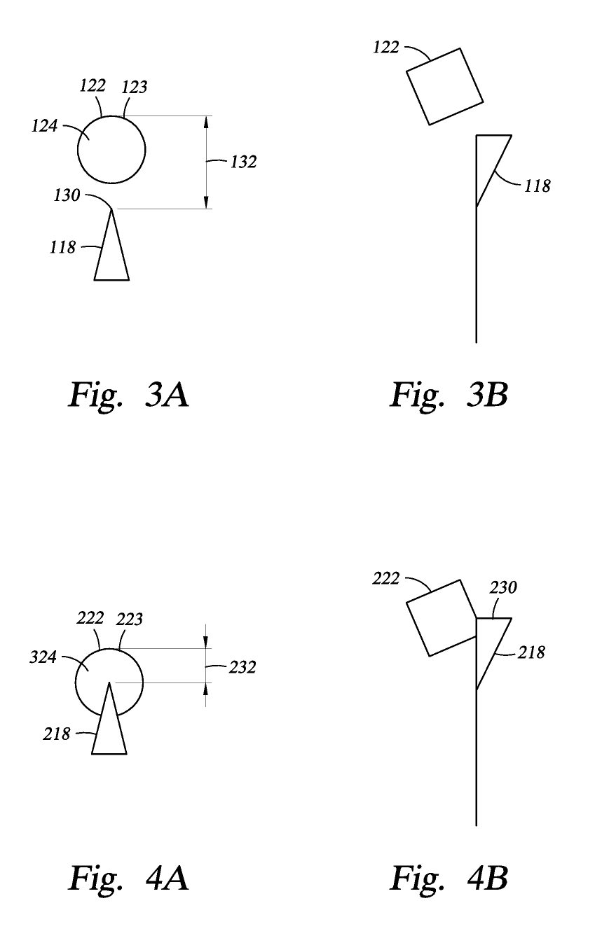

Referring to FIGS. 3A and 3B, partial front and side views, respectively, are depicted showing a relative position of the splitters 118 to the cutters 122. In this embodiment, the splitter edge 130 of each of the splitters 118 are offset a dimension 132 from a cutter edge 123 of the face 124 of the cutter 122.

Referring to FIGS. 4A and 4B, partial front and side views, respectively, are depicted showing an alternate relative position of splitters 218 to cutters 222. A splitter edge 230 of each of the splitters 218 is positioned offset a dimension 232 from a cutter edge 223 of a face 224 of the cutter 222 such that an extension of a line defined by the splitter edge 230 intersects with the face 224.

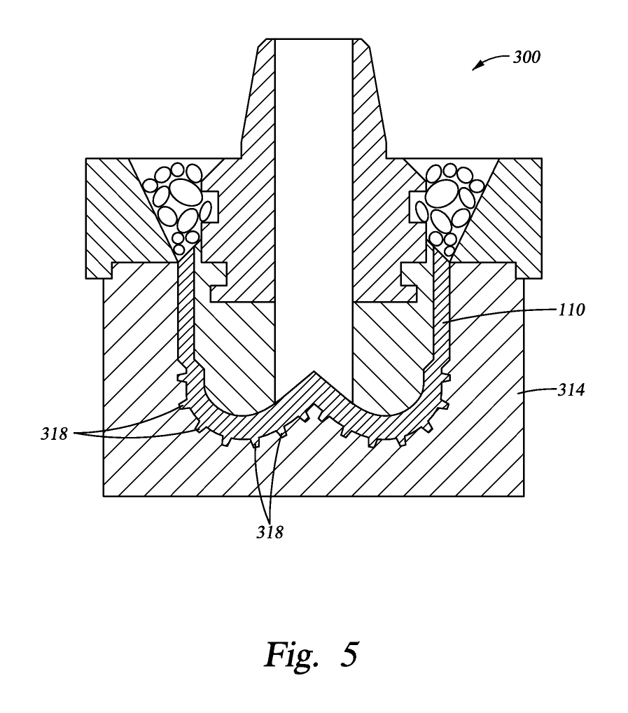

Referring to FIG. 5, a cross-sectional view is depicted of a bit mold 300 with the drill bit 110 disclosed herein positioned therewithin. Molding the drill bit 110 with the splitters 118 integrally formed with the body 114 of the drill bit 110 is one method disclosed herein of producing the drill bit 110. Doing so includes forming a cavity 314 of the bit mold 300 that includes at least one recess 318 that will form the splitter 118. The recess 318 needs a sharp corner therein to form the sharp splitter edge 130 of the splitter 118. Doing so can be difficult with conventional milling processes so electrical discharge machining (EDM) may be a desirable alternative. Powdered materials such as, steel, tungsten carbide, tungsten carbide matrix, polycrystalline diamond, ceramics and combinations thereof, for example are positioned within the bit mold 300 and heated to sinter the powdered material and form the drill bit 110. After which the bit mold 300 can be cooled, opened and the drill bit 110 removed.

It should be noted that embodiments might include filling the recesses 318 with a hardenable material negating the need to heat the material for sintering. Still other embodiments may include filling the recesses 318 with a first material, while filling the balance of the bit mold 300 with a second material. Doing so can allow the splitters 318 to have different material properties than the body 114 such as enhanced strength and wear resistance properties.

Alternately, the drill bit 110 can be directly machined with, for example, a multiple axis automated milling machine. The milling machine can remove material from the body 114 and leave the splitter 118 protruding therefrom. In so doing, avoiding secondary operations to attach the splitter 118 to the body 114 and the potentially detrimental effects associated with such secondary operations as elaborated on above.

While the invention has been described with reference to an exemplary embodiment or embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed:

1. A method of making a drill bit for drilling subterranean formations, comprising:
forming a bit mold defining the drill bit to include at least one recess defining at least one splitter; and
filling the bit mold with at least one material.

2. The method of making the drill bit for drilling subterranean formations of claim 1, wherein the forming includes electrical discharge machining.

3. The method of making the drill bit for drilling subterranean formations of claim 1, wherein the at least one material is selected from the group consisting of steel, tungsten carbide, tungsten carbide matrix, polycrystalline diamond, ceramics and combinations of two or more of the foregoing.

4. The method of making the drill bit for drilling subterranean formations of claim 1, further comprising filling the at least one recess with a first material and filling the balance of the bit mold with a second material.

5. The method of making the drill bit for drilling subterranean formations of claim 1, further comprising removing the drill bit from the bit mold.

6. The method of making the drill bit for drilling subterranean formations of claim 1, further comprising exposing the bit mold to a heat source to sinter the at least one material into the drill bit.
